(19) United States
(12) Patent Application Publication
(10) Pub. No.: US 2015/0061831 A1
(43) Pub. Date: Mar. 5, 2015

(54) KEY AND SECURITY DEVICE

(71) Applicant: InVue Security Products Inc., Charlotte, NC (US)

(72) Inventors: James K. Sankey, Charlotte, NC (US); Jeffrey A. Grant, Charlotte, NC (US); Gary A. Taylor, Fort Mill, SC (US); David N. Berglund, Charlotte, NC (US)

(21) Appl. No.: 14/469,721

(22) Filed: Aug. 27, 2014

Related U.S. Application Data
(60) Provisional application No. 61/871,028, filed on Aug. 28, 2013.

(51) Int. Cl. E05B 73/00; G07C 9/00; E05B 19/00

(52) U.S. Cl. CPC E05B 73/0017; E05B 19/00; G07C 9/00119
USPC 340/5.65; 70/393

(57) ABSTRACT

A key for a security device is provided. The key may include a housing and an actuation member operably engaged with the housing. The key may also include a mechanical component configured to disengage a mechanical member of a security device. The key may further include an electronic component configured to arm and/or disarm a monitoring circuit in electrical communication with a security device. The actuation member is configured to actuate the mechanical component and/or the electronic component.

### CROSS REFERENCE TO RELATED APPLICATIONS

The present application claims the benefit of the filing date of U.S. Provisional Application No. 61/871,028, filed on Aug. 28, 2013, the disclosure of which is incorporated herein by reference in its entity.

### BACKGROUND OF THE INVENTION

Embodiments of the present invention relate generally to keys and security devices of the type commonly used to display an item of merchandise vulnerable to theft.

It is common practice for retailers to display items of merchandise on a security device, such as a display hook or a display fixture, within security packaging commonly referred to as a “safer”, or otherwise on a display surface. The security device or keeper displays an item of merchandise so that a potential purchaser may examine the item when deciding whether to purchase the item. The small size and relative expense of the item, however, makes the item an attractive target for shoplifters. A shoplifter may attempt to detach the item from the security device, or alternatively, may attempt to remove the security device from the display area along with the merchandise. Items of merchandise may also be secured using a display stand to allow users to sample the item for potential purchase. In some instances, the security device is secured to a display support using a lock operated by a key, for example, a mechanical lock. In other instances, the security device is secured to the display support using a lock operated by an electronic key to arm and disarm the security device.

However, retailers are required to employ multiple keys for different types of locks. In addition, keys are susceptible to theft and unauthorized use.

### BRIEF SUMMARY

Embodiments of the present invention are directed to keys, security devices, security systems, and methods. In one embodiment, a key includes a housing and an actuation member operably engaged with the housing. The key also includes a mechanical component configured to disengage a mechanical member of a security device. The key further includes an electronic component configured to arm and/or disarm a monitoring circuit in electrical communication with a security device. The actuation member is configured to actuate the mechanical component and/or the electronic component.

In another embodiment, a security system is provided and includes a key comprising a housing, an actuation member operably engaged with the housing, a mechanical component, and an electronic component. The security system also includes a security device comprising a monitoring circuit and a mechanical member. The mechanical component is configured to disengage the mechanical member of a security device, while the electronic component is configured to arm and/or disarm the monitoring circuit. The actuation member is configured to actuate the mechanical component and/or the electronic component.

In one embodiment, a method for securing a security device comprising a monitoring circuit and a mechanical member is provided. The method comprises disarming the monitoring circuit using an electrical component of a key and disengaging the mechanical member with a mechanical component of the key. The step of disarming and/or disengaging comprises actuating an actuation member of the key.

### BRIEF DESCRIPTION OF THE DRAWINGS

The detailed description of the invention provided below may be better understood with reference to the accompanying drawing figures, which depict one or more embodiments of a security device and method.

FIG. 1 illustrates a key according to one embodiment of the present invention.

FIG. 2 illustrates a key according to another embodiment of the present invention.

FIG. 3 illustrates a schematic view of a key according to one embodiment of the present invention.

FIG. 4 is a perspective end view of a key according to one embodiment of the present invention.

FIG. 5 is a perspective view of a security device according to one embodiment of the present invention.

FIG. 6 is a perspective view of a key engaged with a programming station according to one embodiment of the present invention.

FIG. 7 is a side view of a security device according to one embodiment of the present invention.

FIG. 8 is a side view showing a key engaged with the security device shown in FIG. 7.

FIG. 9 is another side view showing the key engaged with the security device shown in FIG. 7.

FIG. 10 is a side view of a security device according to another embodiment of the present invention.

FIG. 11 is perspective view of the security device shown in FIG. 10 engaged with an item of merchandise and tethered to a recoiler according to an embodiment of the present invention.

### DETAILED DESCRIPTION OF THE INVENTION

Referring now to the accompanying drawing figures, one or more embodiments of a key 10 for cooperating with a security device 12 are shown. The security device 12 may be one of the type commonly used to display one or more articles of merchandise (not shown for purposes of clarity) within a display area of a retail store. By way of example, and not by limitation, the security device 12 is a merchandise display hook for displaying relatively, small, expensive consumer products, for example, compact discs (CDs), digital video discs (DVDs), battery packs, etc., on a display support. The display support could be any suitable support, such as wire grid, horizontal bar rack, slatwall (also known as slatboard), wall, table, desk, countertop or other secure structure. Other examples of a security device 12 according to the present invention without limitation include merchandise display fixtures, merchandise tags (or “bugs”), stop locks, cable locks and wraps, and merchandise safers. In some embodiments, the security device 12 may be a display module, a puck, or an alarm that is mountable to a display surface, support, or the like, for displaying an item of merchandise. The item of merchandise may be a display model or an operational sample of electronic merchandise, such as cellular telephones, portable computers (e.g., notebooks, laptops, tablets, etc.), e-readers, media players, and the like, for a customer to examine before making a decision to purchase the item. The item of merchandise may be displayed in a manner that permits a prospective purchaser to evaluate the operation and features of the merchandise, while protecting the merchandise from a potential thief. In some example embodiments, the security devices 12 are similar to the Locking Hooks, Smart Locks, and PODs manufactured by InVue Security Products Inc.

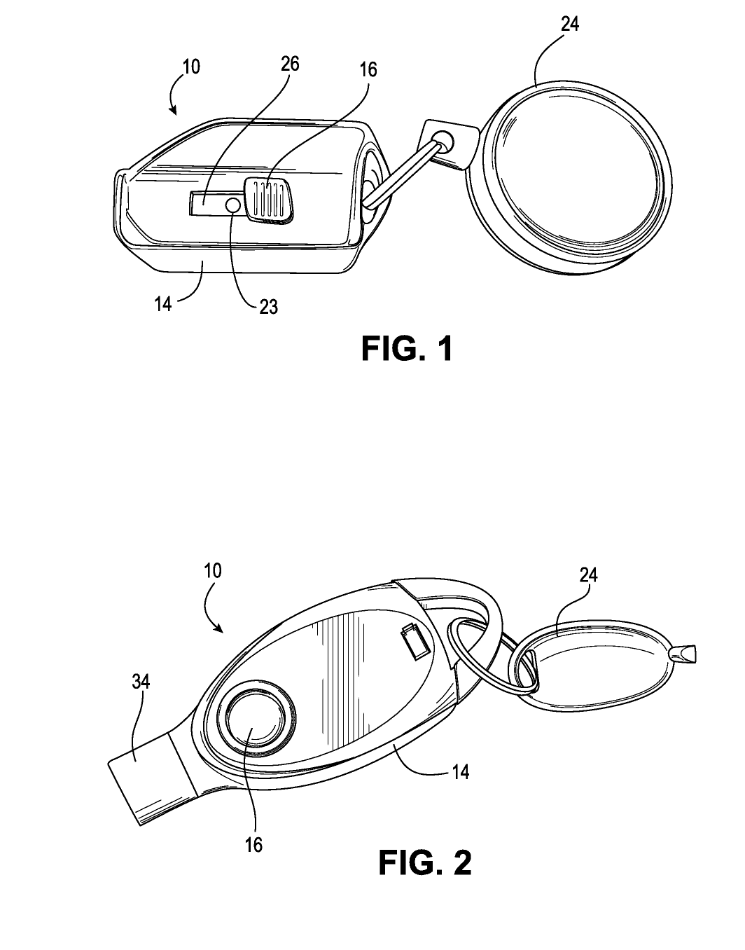

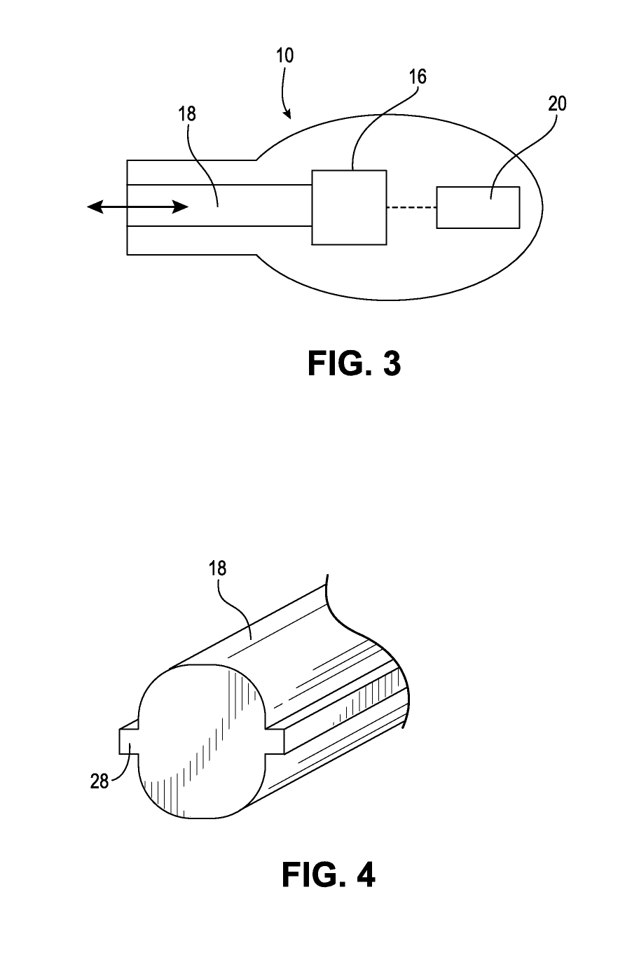

In one embodiment, a key 10 for a security device 12 is provided and generally includes a housing 14 and an actuation member 16 operably engaged with the housing (see, e.g., FIGS. 1 and 2). For example, the actuation member 16 may be at least partially disposed within the housing 14. The key 10 further includes a mechanical component 18 and an electronic component 20 operably engaged with the actuation member 16 and configured to cooperate with a security device 12 (see, e.g., FIG. 3). In some embodiments, the mechanical component 18 is configured to mechanically engage the security device 12, while the electronic component 20 comprises communication capability for communicating with the security device. The actuation member 16 may be configured to move the mechanical component 18 and/or the electrical component 20 for cooperation with the security device 12, and the actuation member 16 may be configured to be locked upon expiration of a predetermined period of time such that the actuation member is unable to actuate the mechanical component and/or the electrical component for cooperating with the security device. Thus, upon expiration of a particular period of time, the key 10 is unable to be used to lock/arm or unlock/disarm a security device 12. In this way, stolen keys will be rendered useless after a predetermined period of time. In addition, the key 10 can be used interchangeably with different types of security devices 12 such that a user is only required to carry one key. Thus, the key 10 may be “multi-purpose” in that the key may be used for different lock types (e.g., mechanical locking hooks, electronic locks, display modules, keepers, cable locks, etc.).

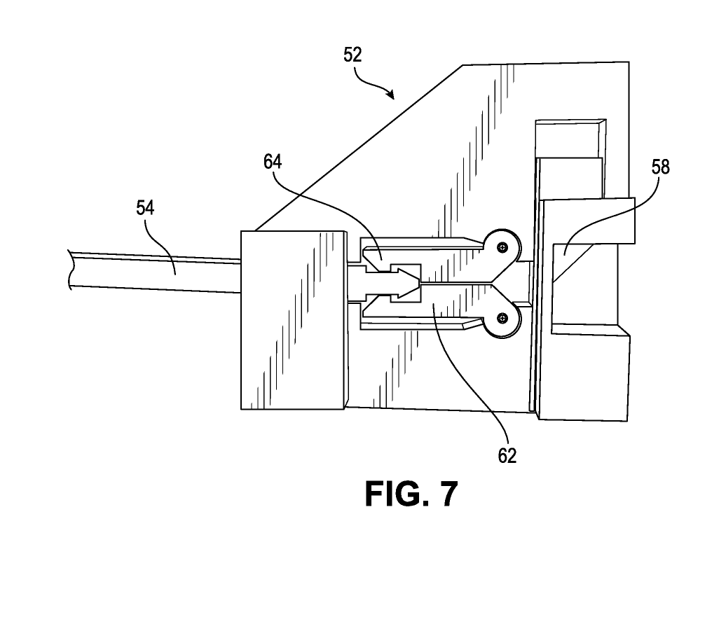

In other embodiments, the mechanical component 18 is operably engaged with the actuation member 16 and is configured to cooperate with a mechanical member of the security device 12 (see, e.g., FIGS. 7-9), while the electrical component 20 is operably engaged with the actuation member and is configured to cooperate with the security device. The mechanical component 18 may be operably engaged with the electrical component 20 such that actuation of the actuation member 16 is configured to actuate the mechanical component and/or the electrical component for cooperation with the security device 12, respectively. In some cases, the actuation member 16 is configured to actuate both of the mechanical 18 and the electrical 20 components.

In some embodiments, the actuation member 16 is configured to lock, or otherwise render inoperable, the mechanical 18 and/or electrical 20 components. Thus, the actuation member 16 may prevent the mechanical 18 and/or electrical 20 components from moving relative to the housing 14 or otherwise being actuated. In other embodiments, the key 10 may further include a separate locking mechanism 23 that is coupled to the actuation member (see, e.g., FIG. 1). Thus, the locking mechanism 23 may be configured to engage the actuation member 16 to prevent actuation thereof.

The housing 14 may be any suitable housing configured to at least partially receive the mechanical 18 and electrical 20 components, as well as the actuation member 16, therein. For example, the housing 14 may be a single piece design or may include a plurality of components joined into a unitary member (e.g., via snap fit, fasteners, adhesive, and/or molding). In one example, the housing 14 includes two halves that are joined together to define an internal cavity. The housing 14 may define an internal cavity for accommodating various components, including the mechanical 18 and electrical 20 components, the actuation member 16, and/or the locking mechanism 23. The housing 14 may also house various other components, such as a controller, a logic control circuit, or a printed circuit board, a battery, and/or an EAS tag. The housing 14 may also be coupled to various other optional components, such as a keychain 24, lanyard, or the like (see, e.g., FIGS. 1, 2, and 6). The housing 14 may be a variety of sizes and configurations, and may be suitably sized for placement within a user's pocket or on a key chain. The housing 14 may include one or more openings for accommodating the mechanical 18 and electrical 20 components, such as for allowing the mechanical and/or electrical components to be moved into and out of the housing. In one embodiment, the housing 14 may include a single opening for accommodating both of the mechanical 18 and electrical 20 components, while in another embodiment, the mechanical and electrical components may be disposed within independent openings of the housing. Similarly, the housing 14 may include an opening or channel 26 defined therein for receiving the actuation member 16. For instance, the actuation member 16 may be a manually operated button that is operable by the user and is operably engaged with the mechanical 18 and/or electrical 20 components.

The actuation member 16 may be any device, mechanism, or feature that is configured to actuate the mechanical 18 and/or electrical 20 components. For example, the actuation member 16 may be a manually actuated member, such as a push button, sliding mechanism, or the like. Alternatively, the actuation member 16 may be an automatically actuated member, such as an actuation member driven by a motor. In this regard, the actuation member 16 may be a linear actuator driven by a motor. The automatic actuation may occur, for example, in response to a user depressing a button or activating a switch. In one embodiment, the actuation member 16 is an electro-mechanical switch such that engagement of the switch with the security device actuates the mechanical 18 and/or electrical 20 components. For instance, the switch could be a plunger or pressure switch that is configured to engage the security device 12 thereby actuating the mechanical 18 and/or electrical 20 components. The actuation member 16 may be in communication with a logic control circuit, controller, or PCB of the key for actuating the actuation member in response to a signal from the logic control circuit, controller, or PCB. Examples of actuation members that may be employed with embodiments of the present invention may be found, for example, in International Application No. PCT/US2014/40635, filed on Jun. 3, 2014, which is hereby incorporated by reference in its entirety.

Similar to the actuation member 16, the locking mechanism 23 may be a mechanical and/or electrical locking mechanism. Thus, as used herein, the term “locking mechanism” should be broadly construed to include any device, mechanism, or feature that physically locks, secures or protects the key 10 from further use. For example, the locking mechanism 23 could be a physical barrier that prevents the actuation member 16, mechanical component 18, and/or electrical component 20 from being displaced relative to the housing 14 or otherwise actuated to lock/arm or unlock/disarm a security device 12. Or, the locking mechanism 23 may be an electrically or an electro-mechanically controlled mechanism, such as a motor driven mechanism that is actuated to prevent the actuation member 16, the mechanical component 18, and/or the electrical component 20 from being displaced or otherwise operated. Alternatively, the locking mechanism 23 could render the actuation member 16 inoperable such that the actuation member is incapable of being actuated. The locking mechanism 23 may be in communication with a logic control circuit, controller, or PCB of the key 10 such that the locking mechanism is configured to be actuated to lock or unlock the actuation member 16 in response to a signal from the logic control circuit, controller, or PCB.

In some cases, the actuation member 16 and the locking mechanism 23 may be separate components, while in other cases the actuation member and the locking mechanism may be integrated into a single component or otherwise operably engaged with one another. For example, where the actuation member 16 is a motor driven actuator, the locking mechanism 23 may also be operated via the motor driven actuator such that actuation of the motor in one direction actuates the mechanical 18 and/or electrical 20 components while actuation of the motor in an opposite direction or de-actuation of the motor locks the mechanical and/or electrical components.

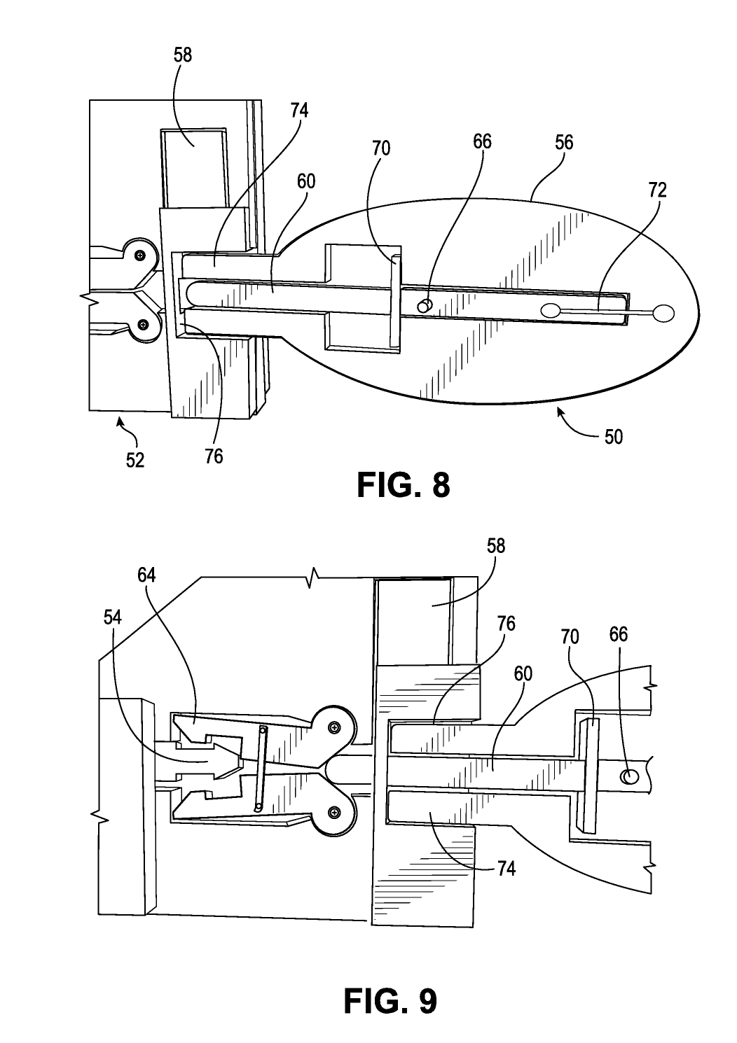

The key 10 may include a mechanical component 18 and an electrical component 20 (see, e.g., FIG. 3). For example, the mechanical component 18 may be configured to cooperate with a security device 12 having a mechanical member, such as, for example, a lock mechanism, a latch, or the like. In one embodiment, the mechanical component 18 may be configured to extend outwardly from the housing 14 to disengage a mechanical member of a security device 12, as well as retract relative to the housing 14. Thus, the mechanical component 18 could be a protrusion, extendable member, or the like that is configured to engage a mechanical member of the security device 12. In other embodiments, both the housing 14 and the mechanical component 18 are configured to cooperate with the security device 12. For instance, the housing 14 may be configured to engage a mechanical member of the security device 12, and then the mechanical component 18 may be configured to be actuated to further engage the mechanical member or a second mechanical member to disengage or otherwise mechanically unlock the security device (see, e.g., FIGS. 8-9).

The mechanical component 18 may include a particular size and shape for cooperating with a complementary size and shape of the security device 12. In one embodiment, the mechanical component 18 includes an irregular shape that is configured to engage a complementary irregular-shaped opening defined in the security device 12. For example, FIG. 4 illustrates a key 10 having a mechanical component 18 with a generally circular cross section with a pair of opposing protrusions 28. Of course, any desired cross section may be employed, although the cross section would typically be a proprietary shape and configuration that could not be readily duplicated. The security device 12 may further require rotation of the key 10 while the mechanical component 18 is engaged therewith. For example, a partial or complete turn of the key 10 may disengage a mechanical member of the security device 12 for locking or unlocking a lock mechanism. In some cases, the mechanical component 18 may include a magnet or magnetically attractable material that is configured to interact with a corresponding magnetically attractable material or magnet associated with the mechanical member.

In one embodiment, the mechanical component 18 first engages the security device 12 and then the electrical component 20 then is able to arm or disarm the security device. For example, the mechanical component 18 may be configured to first disengage a mechanical member of the security device 12, and then the electrical component 20 may be configured to arm or disarm the security device. In this embodiment, the electrical component 20 would be able to arm or disarm the security device 12 only when the mechanical member is first disengaged. In other embodiments, the electrical component 20 may be configured to first disarm the security device 12, and then the mechanical component 18 may be configured to disengage or unlock the security device. Of course, the operations of the mechanical 18 and electrical 20 components could alternatively occur simultaneously.

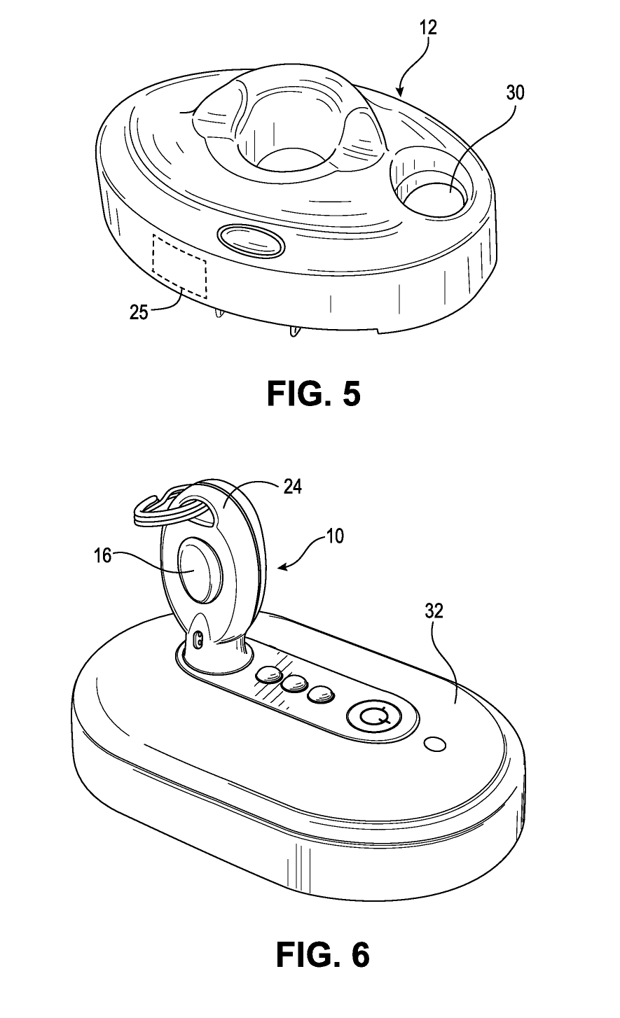

The electrical component 20 may be configured to cooperate with a security device 12 for arming and disarming a monitoring circuit 25 that is in electrical communication with the security device (see, e.g., FIG. 5). For example, the electrical component 20 may be configured for various forms of wireless communication with a security device 12, such as optical (e.g., infrared), acoustical (e.g. ultrasonic), radiofrequency (RF), or magnetic pulse. In one embodiment, the energy signal emitted by the electrical component 20 is configured to cooperate with an infrared sensor of the type shown and described in U.S. Pat. No. 7,737,844, the disclosure of which is incorporated herein by reference in its entirety. In one embodiment, data and/or power is transferred from the key 10 to the security device 12 by wireless communication, such as by infrared (IR) optical transmission, as shown and described in U.S. Pat. No. 7,737,843, U.S. Pat. No. 7,737,845, and U.S. Patent Publication No. 2012/0047972, each of which is incorporated herein by reference in its entirety.

In some embodiments, the electrical component 20 may be programmed with a security code and the security device 12 may be programmed with the same security code, for example, by the key or by the same security device that programmed the key. Thereafter, the key 10 may be positioned within or proximate to a transfer port 30 of the security device 12, and the actuation member 16 may be depressed to activate communication of the security code between the key and the security device. FIG. 6 shows one embodiment of a security device 12 including a transfer port 30 that is configured to communicate with a key 10. In one example, the electronics of the key 10 verify that the security device 12 has a security code, and the electronics (e.g., a printed circuit board) disposed within the security device then query the key for its security code. The security code may be wirelessly communicated between the security device 12 and the key 10 by Infrared (IR) optical transmission. Alternatively, the security code may be transmitted and received by electrical contacts, acoustic transmission (e.g., RF signals) or magnetic induction.

In the event that the security code of the key 10 matches the security code of the security device 12, the key may then be permitted to transfer electrical power to the security device, for example, to operate a lock mechanism of the security device. The key may transfer electrical power to the security device 12 in any suitable manner, such as by electrical contacts, acoustical transmission (e.g. RF signals) or magnetic induction. Further discussion regarding data and electrical communication between an electronic key 10 and a security device 12 may be found, for example, in U.S. Publication No. 2012/0047972, which is hereby incorporated by reference in its entirety. It is understood that in other embodiments, the key 10 may only transfer a wireless signal to arm/disarm the security device 12 and does not transfer electrical power to the security device.

Power may be transferred from the key 10 directly to the lock mechanism via one or more conductors. For example, a conductor may be coupled to a mechanical lock mechanism, and when electrical power is conducted through the conductor, a state change occurs thereby resulting in operation of the lock mechanism. In one example, the conductor is coupled to a shape memory material (e.g., Nitinol) such that electrical power transferred through the conductor results in a change in shape of the shape memory material (e.g., contraction). Such a change in shape may cause a mechanical actuation (e.g., linear or rotary) of the lock mechanism to thereby lock or unlock the lock mechanism. Examples of using such shape memory material for a lock mechanism may be found, for example, in U.S. application Ser. No. 14/328,051, filed on Jul. 10, 2014, which is hereby incorporated by reference in its entirety. In other embodiments, the lock mechanism may cooperate with a motor or solenoid for operating the lock mechanism. In some embodiments, the mechanical component 18 is configured to partially disengage a lock mechanism, and then the electrical component 20 is configured to actuate the lock mechanism to fully disengage the lock mechanism.

The key 10 may be programmed with a security code, for example, a Security Disarm Code (SDC). The key 10 and the security device 12 may each be pre-programmed with the same SDC into a respective permanent memory. Alternatively, the key 10 may first be programmed with the SDC by a programming station 32, and the security device 12 may subsequently be programmed with the same SDC by the programming station or by the key (see, e.g., FIG. 6). The key 10 may be provisioned with a single-use (e.g., non-rechargeable) internal power source, such as a conventional or extended-life battery. Alternatively, the key 10 may be provisioned with a multiple-use (e.g., rechargeable) internal power source, such as a conventional capacitor or rechargeable battery. In some embodiments, the key 10 may be pre-programmed with a security code or may be self-programming in other embodiments.

In one embodiment, the key 10 may include a time-out function, as explained in further detail below. More particularly, the ability of the actuation member 16 to actuate the mechanical 18 and/or electrical 20 components may be deactivated after a predetermined time period. By way of example, the key 10 may include a logic control circuit that is configured to be deactivated after about six to twelve hours (e.g., about eight hours) from the time the key was programmed or last refreshed by a programming station 32. In this manner, an authorized sales associate typically must program or refresh the key assigned to him or her at the beginning of each work shift. Thus, the key 10 would have to be programmed or refreshed with the SDC by a programming station, which is typically monitored or maintained at a secure location, in order to reactivate the logic control circuit of the key. Other forms for reprogramming or refreshing the SDC may be used such as, for example, inputting a code, charging the key with an authorized charger, etc.

The mechanical 18 and the electrical 20 components may be independent of one another or operably engaged with one another. In this regard, the mechanical 18 and electrical 20 components may be independently actuated or actuated simultaneously. In one embodiment, the mechanical 18 and electrical 20 components are operably engaged with one another. Thus, the mechanical 18 and electrical 20 components may be moved in unison with respect to the housing 14. Moreover, in one embodiment, actuation of the actuation member 16 actuates both of the mechanical 18 and electrical 20 components simultaneously. For instance, where the actuation member 16 is a sliding member or a push button, actuating the actuation member causes both the mechanical 18 and electrical 20 components to be extended out of the housing 14 such that the mechanical component is able to engage a mechanical member of the security device 12 and the electrical component emits a signal for arming or disarming a monitoring circuit 25, an alarm, or the like. Alternatively, actuation of the actuation member 16 may only cause the mechanical component 20 to be extended from the housing 14, while the electrical component 20 is configured to emit a signal from within the housing to arm or disarm the security device 12. Where the signal is a wireless signal, such as an IR signal, the signal may have no effect on a mechanical member or lock, but would be operable to arm/disarm an electrical or electro-mechanical lock.

As discussed above, the actuation member 16 may be configured to move the mechanical 18 and/or the electrical 20 components relative to the housing 14. In one embodiment, the actuation member 16 comprises a slide assembly configured for sliding movement of the mechanical component 18 and/or the electrical component 20 within the interior cavity (see, e.g., FIG. 1). For instance, the actuation member 16 may include a finger operated button that is configured to slide within a channel defined in the housing 14. The actuation member 16 may be operably coupled to the logic control circuit, controller, or PCB of the key 10 such that movement of the key in one direction actuates the electrical component 20. In addition, movement of the actuation member 16 extends the mechanical component 18 outwardly of the housing 14. The sliding mechanism may be configured to automatically retract the mechanical 18 and/or the electrical 20 components into the housing 14, such as a biasing member (e.g., a spring). Alternatively, the user of the key 10 may manually retract the mechanical 18 and/or the electrical 20 components into the housing 14 by moving the button in an opposite direction.

As also discussed above, the key 10 may be configured to time out after a predetermined period of time. In other words, after a predetermined period of time has elapsed, the actuation member 16 is rendered inoperable for actuating the mechanical 18 and/or the electrical 20 components. For example, where the actuation member 16 is manually operated, the actuation member may be unable to be moved with respect to the housing 14 due to engagement with a locking mechanism 23. Similarly, where the actuation member 16 is automatically actuated (e.g., electrically or electro-mechanically operated), the actuation member may be self-locking to prevent the actuation member from being operated or otherwise locking/unlocking or arming/disarming a security device 12. Thus, the key 10 would have to be reprogrammed or refreshed with an appropriated security authorization in order to reactivate the key so that the actuation member 16 is again able to be actuated. In one embodiment, the key 10 may be operable for a predetermined period of time, and the actuation member 16 may be used for any number of authorized uses within this time period. In the instance where the actuation member 16 is electronically or electro-mechanically driven (e.g., via a motor), the key 10 may be configured to determine the battery level of the key to ensure that enough power is available to retract the mechanical 18 and/or the electrical 20 components within the housing 14 to prevent unauthorized use and ensure that the mechanical and/or the electrical components are inaccessible.

In one embodiment, the actuation member 16 may be configured to automatically actuate the mechanical 18 and/or the electrical 20 components for a predetermined period of time. For instance, when the actuation member 16 is actuated, the mechanical 18 and/or the electrical 20 components may be actuated for a limited amount of time to allow a user to lock/unlock or arm/disarm a security device 12. According to various examples, the mechanical 18 and/or the electrical 20 components may be actuated for about 2 seconds or less, about 3 seconds or less, about 4 seconds or less, about 5 seconds or less, or about 10 seconds or less. Upon the predetermined period of time elapsing, the actuation member 16 may automatically retract the mechanical 18 and/or the electrical 20 components within the housing 14 or otherwise render the mechanical and/or the electrical components inoperable.

Embodiments of the key 10 may also be configured to limit tampering or unauthorized use of the key. For example, the key 10 may include a shroud 34 that projects from the housing 14 that is configured to prevent the mechanical 18 and/or the electrical 20 components from being tampered with when extended. In one embodiment, the shroud 34 extends outwardly from the housing 14 and is configured to surround a portion of the mechanical 18 and/or the electrical 20 components. Thus, should an unauthorized user attempt to glue, tape, or otherwise tamper with the key 10 to attempt to prevent the mechanical 18 and/or the electrical 20 components from being retracted into the housing, the shroud 34 limits the ability to do so.

FIGS. 7-9 show another embodiment of a key 50 and a security device 52. In this example, the security device 52 is an end assembly for engaging a locking hook. The security device 52 is removably locked to a rod 54 via one or more mechanical members. As illustrated, the key 50 may include features that are configured to mechanically engage the security device 52. As discussed above, both the housing 14 and the mechanical component 18 may be configured to cooperate with the security device 12. Thus in this embodiment, the housing 56 may be configured to engage a first engagement member 58 of the security device 52, such as by inserting a shroud 74 within an opening 76 defined in the security device 52. The mechanical component 60 may then be configured to be actuated to further engage a second engagement member 62, which in turn disengages a third engagement member 64 to thereby disengage or otherwise mechanically unlock the rod 54 from the end assembly. Thus, the key 50 may be configured to mechanically engage any number of engagement members of the security device 52 to effectuate unlocking thereof. When the key 50 is engaged with the security device 52 (see, e.g., FIG. 8), the actuation member 66 may actuate the electrical component 70, which may recognize that the key is engaged with a security device or that a security device is present (e.g., via a sensor). In one embodiment, the electrical component 70 may be retracted relative to the mechanical component 60 when the electrical component is actuated. Thus, the security device 52 may not require communication with the electrical component 70 to arm or disarm the security device, as the security device may only be mechanically locked. In other words, the electrical component 70 may be retracted relative to the housing 56 to allow the mechanical component 60 to be actuated to unlock the security device 52. In other embodiments, the key 50 may be configured to also arm or disarm the security device 52 following actuation of the mechanical component 60. Moreover, the key 50 may include a biasing member 72 that is configured to retract at least the mechanical component 60 within the housing 56. Thus, where the actuation member 66 is actuated to extend the mechanical component 60 out of the housing 56, the biasing member 72 may be configured to retract the mechanical component within the housing.

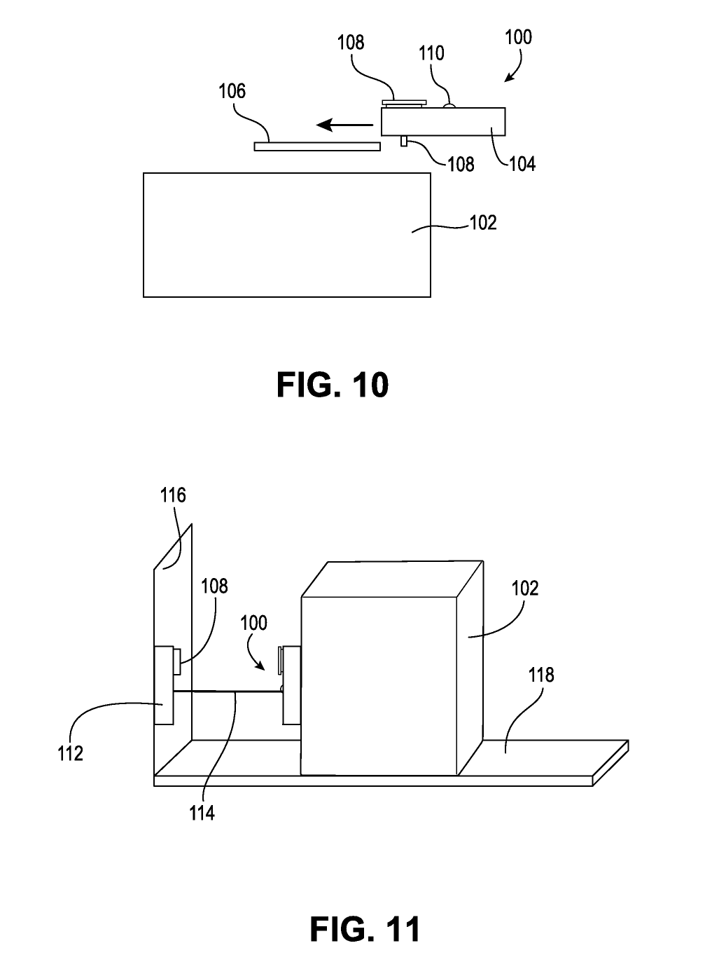

FIGS. 10 and 11 illustrate another embodiment wherein the security device 100 is configured to be removably attached to an item of merchandise 102 (e.g., a retail package). For example, the security device 100 may include a housing 104 that is removably attached to a sled 106, such as in sliding engagement. The sled 106 could be affixed to the item of merchandise 102, such as with an adhesive. The security device 100 may include a plunger switch 108 that is configured to sense when the housing 104 is removed from the item of merchandise 102 or the sled 106 in an unauthorized manner. The housing 104 may be removably attached to the sled 106 with a locking mechanism that is configured to be locked or unlocked from the sled with a key, as well as armed or disarmed with the key. Thus, the housing 104 may include a monitoring circuit 25 as discussed above, as well as a port 108 for communicating with a key (e.g., via wireless communication). The housing 104 may include an LED 110 or other indicator for indicating that the monitoring circuit 25 is armed or disarmed. In one embodiment, the key is similar to that shown in FIG. 5 and is configured to electrically communicate with the security device 100 as well as mechanically engage the housing 104. Thus, the key may include a mechanical component 18 for engaging the housing and an electrical component 20 for communicating with the monitoring circuit 25 (e.g., via IR communication).

FIG. 11 shows that the security device 100 may be tethered to an alarming recoiler 112, wherein a tether 114 is configured to extend and retract relative to the recoiler. As such, the item of merchandise 102 may be extended and retracted relative to the recoiler 112 for examination by a customer when the security device 100 is attached to the item. As shown, the alarming recoiler 112 could also include a port 108 operably engaged with a monitoring circuit 25, wherein the monitoring circuit is configured to determine whether the tether 114 has been cut or if the recoiler has been removed from a support surface or wall 116 in an unauthorized manner. The alarming recoiler 112 may also include a port 108 that is configured to communicate with a key for arming or disarming the recoiler. The item of merchandise 102 may be configured to be supported on a display surface 118, shelf, or the like.

The foregoing has described one or more embodiments of a key for a security device or security packaging of the type commonly used to display an item of merchandise, a security device, and a system. Embodiments of a key, security device, and system have been shown and described herein for purposes of illustration. Those of ordinary skill in the art, however, will readily understand and appreciate that numerous variations and modifications of the invention may be made without departing from the spirit and scope of the invention.

That which is claimed is:

1. A key for a security device, comprising:
a housing;
an actuation member operably engaged with the housing;
a mechanical component configured to disengage a mechanical member of a security device; and
an electronic component configured to arm and/or disarm the security device,
wherein the actuation member is configured to actuate the mechanical component and/or the electronic component.

2. The key of claim 1, wherein the electronic component is operable for arming and/or disarming a monitoring circuit that is in electrical communication with the security device.

3. The key of claim 1, wherein the electronic component is operable for disarming the security device.

4. The key of claim 1, wherein the housing defines an interior cavity for at least partially housing the mechanical component and the electronic component and wherein the mechanical component and/or the electronic component are movable relative to the housing in response to movement of the actuation member.

5. The key of claim 4, wherein the housing comprises a slide assembly configured for sliding movement of the mechanical component and/or the electronic component within the interior cavity.

6. The key of claim 1, wherein the mechanical portion comprises an extendable member relative to the housing.

7. The key of claim 1, wherein the electronic component is configured to wirelessly communicate a security code to the security device.

8. The key of claim 1, wherein the electronic component is configured to transmit power to the security device for locking and/or unlocking the security device.

9. The key of claim 8, wherein the electronic component is configured to transmit power inductively to the security device.

10. The key of claim 1, wherein the actuation member is movable relative to the housing.

11. The key of claim 1, further comprising a locking mechanism operably engaged with the actuation member and configured to lock the actuation member upon expiration of a predetermined period of time.

12. The key of claim 1, wherein the actuation member is at least partially disposed within the housing.

13. The key of claim 1, wherein the actuation member is configured to first actuate the mechanical component to disengage a mechanical member of a security device, and wherein the actuation member is further configured to subsequently actuate the electronic component to arm and/or disarm the security device only when the mechanical component has disengaged the mechanical member of the security device.

14. The key of claim 1, wherein the mechanical component is configured to unlock the security device after the electronic component has disarmed the monitoring circuit.

15. The key of claim 1, wherein the electronic component is configured to disarm the security device after the mechanical component has disengaged the mechanical member of the security device.

16. The key of claim 1, wherein the actuation mechanism is configured to be locked upon expiration of a predetermined period of time such that the actuation member is incapable of actuating the electrical component for cooperation with the security device.

17. A security system comprising:
a key comprising:
a housing;
an actuation member operably engaged with the housing;
a mechanical component; and
an electronic component; and
a security device comprising a monitoring circuit and a mechanical member,
wherein the mechanical component is configured to disengage the mechanical member of a security device,
wherein the electronic component is configured to arm and/or disarm the monitoring circuit, and
wherein the actuation member is configured to actuate the mechanical component and/or the electronic component.

18. A method for securing a security device comprising a monitoring circuit and a mechanical member, the method comprising:
disarming the monitoring circuit using an electrical component of a key; and
disengaging the mechanical member with a mechanical component of the key,
wherein the step of disarming and/or disengaging comprises actuating an actuation member of the key.

19. The method of claim 18, wherein the step of disengaging the mechanical member occurs prior to the step of arming or disarming the monitoring circuit.

20. The method of claim 18, wherein the step of disengaging the mechanical member occurs after the step of arming or disarming the monitoring circuit.
